(19) United States
(12) Patent Application Publication
(10) Pub. No.: US 2003/0046555 A1
(43) Pub. Date: Mar. 6, 2003

(54) Identity verification using biometrics

(76) Inventors: Shawn J. Bradley, Missoula, MT (US); Richard F. Peralta, Stevensville, MT (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/945,261

(22) Filed: Aug. 31, 2001

(51) Int. Cl. H04L 9/00

(52) U.S. Cl. 713/186; 713/200

(57) ABSTRACT

In accordance with the present invention, authorization to gain access to an account is carried out in two phases. During the first phase, a biometric image stored on a microchip disposed on a token is compared to a biometric image supplied by the token holder at the time and site of the transaction. If there is a match between the two biometric images in the first phase, then the second phase of the verification is carried out during which data associated with and extracted from the biometric image supplied by the account holder—prior to the issuance of the token—is compared to data associated with and extracted from the biometric image stored on the microchip or supplied by the token holder at the time and site of the transaction. If there is a match between the two data during the second phase, then access to the account is granted.

### BACKGROUND OF THE INVENTION

The present invention relates to identity verification systems, and more particularly to identity verification systems based on biometrics.

The use of a token to effectuate financial transactions has become more pervasive in today's financial market. A token, such as a debit or credit card, typically identifies both the account holder as well as the account that is the subject of the financial transaction.

The rise in the number and types of accounts accessible by, for example, a debit or credit card has seen a parallel increase in the level of criminal activities related to unauthorized use of such credit or debit cards. Credit card fraud, which occurs in many different forms, often largely arises as a result of either stolen or counterfeit cards.

Typically, debit cards are used in conjunction with a personal identification number (PIN). A PIN is designed to prevent unauthorized use of lost or stolen cards. However, a number of techniques have been used by unauthorized users to obtain PINs from unwary cardholders. Such techniques include, for example, using Trojan horse automated teller machines (ATMs) that dispense cash but record the PINs, using fraudulent debit devices that also record the PINs, or watching the account holder enter a selected PIN into an ATM with the aid of binoculars. A PIN obtained via any of the above techniques is subsequently used in a counterfeit card to fraudulently withdraw funds from the targeted account.

Fraud committed by account holders is also on the rise. An account holder may withdraw cash from the account—with the card which is in his possession—and deny responsibility for the withdrawal by claiming that he had lost the card—on which he claims he had written the PIN associated with the card—and thus asserting that someone else withdrew cash from the account.

In an effort to improve the security and reliability of token-based transactions, new techniques have been developed. In accordance with one technique, a binary number extracted from an authenticated biometric—taken from the account holder to whom the token is issued—is stored on the token. To gain access to the account and thus to carry out a transaction, the token holder is required to supply the requested biometric at the transaction site. Data extracted from the biometric supplied at the transaction site by the token holder is then compared to the data stored on the token to determine if the two match. If a match exists between the two data, the token holder's identity is verified and access to the account is authorized.

Various biometrics have been considered for use with smartcards, such as fingerprints, hand prints, voice prints, retinal images, handwriting samples and the like. An example of a biometric-based smartcard is found in U.S. Pat. No. 5,280,527 issued to Gullman et al. which disclose a credit card sized token (referred to as a biometric security apparatus) containing a microchip in which a sample of the authorized user's voice is stored. In order to gain access to an account, the user must insert the token into a designated slot of an ATM and then speak to the ATM. If a match is found between the user's voice and the sample recording of the voice stored on the microchip, access to the account is granted. Alternatively, the ATM may prompt the user for an additional code, such as a PIN which is also stored on the token, in order to authorize account access.

Although Gullman et al' system reduces the risk of unauthorized access when compared against conventional PIN-based systems, to the extent that the credit card and the microchip disposed therein may be tampered with, Gullman's system does not provide the level of reliability and security that is often required in today's highly diverse and ever expanding financial transactions.

### SUMMARY OF THE INVENTION

In accordance with the present invention, an authorization system grants access to an account only if (i) a biometric image stored on a microchip disposed on a token matches a biometric image supplied by the token holder at the time and site of the transaction and (ii) data associated with and extracted from the biometric image supplied by the account holder—prior to the issuance of the token—matches a corresponding data associated with and extracted from either the biometric image stored on the microchip or that supplied by the user at the transaction site.

In some embodiments of the present invention, the token is a card and the biometric is a finger print. The microchip stores the finger print image in, for example, bitmap, Tiff or JPEG format. The data extracted from the finger print's image is, for example, 8 bits wide and is stored in a database that may be physically located away from the transaction site.

To request access to an account from a transaction site, a cardholder first supplies his card to a computer system located at the transaction site. The cardholder is then instructed to place his finger on a scanner, thereby to capture the cardholder's finger print image. An image of the same finger print captured prior to the issuance of the card is stored inside a microchip on the card. If a match exists between the finger pint image stored in the microchip and that supplied by the cardholder at the transaction site, the system proceeds to the second phase of the verification.

During the second verification phase, previously extracted security data stored in a database is compared with a corresponding data extracted from either the finger print image stored in the microchip or the finger print supplied by the user at the transaction site. If there is a match between the two data compared during the second verification phase, then access to the account is granted if the account meets certain qualifying requirements.

### BRIEF DESCRIPTION OF THE DRAWINGS

FIG. 1 is a front view of a token, in accordance with one embodiment of the present invention.

FIG. 2 is a perspective view of an authorization terminal, in accordance with one embodiment of the present invention.

FIG. 3 is a flowchart illustrating the process during a first phase of authorization of access to an account, in accordance with one embodiment of the present invention.

FIG. 4 is a flowchart illustrating the process during a second phase of authorization of access to an account, in accordance with one embodiment of the present invention.

### DESCRIPTION OF THE SPECIFIC EMBODIMENTS

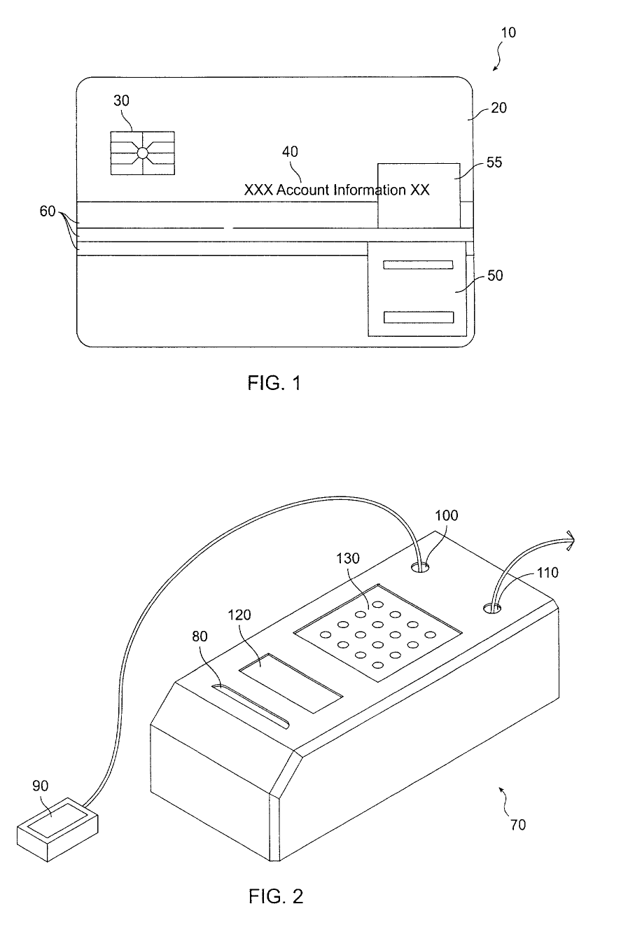

FIG. 1 is a front view of token 10, in accordance with one embodiment of the present invention. Token 10 includes a body 20 which may be formed from, for example, plastic, metal, or the like. Body 20 further includes integrated circuit (hereinafter alternatively referred to as microchip) 30 in which an image of, for example, the finger print of the person to whom the card is issued (hereinafter referred to as the account holder) is stored. The finger print image is stored in microchip 30 in one of many commercially available formats such as, Tiff, JPEG, bitmap, etc. Token 10 optionally includes a data carrying medium 40 in the form of raised symbols that contain additional data related to the account for which token 10 is issued. Such data may include, for example, credit or debit account number or the like.

Token 10 optionally also includes mediums 50 and 55 as well as magnetic stripes 60 on which account related data may also be stored. Medium 50 may include such information as the name or the logo of the entity issuing or affiliated with token 10. Medium 55 may include, for example, a hologram on which parts of the raised symbols of data carrying medium 40 are positioned. Magnetic stripes 60 include such information as the name or the address of the account holder, etc.

Although, the biometric image stored in microchip 30 is a fingerprint image, it is understood that other biometrics such as hand prints, retinal images, handwriting samples and the like may also be stored in microchip 30, in accordance with the present invention.

Token 10 is provided to the account holder by an issuing entity, such as a bank, a credit card company, an agency. For example, token 10 may be a credit card or debit card issued by a bank or it may be a driver's license issued by the department of motor vehicles, etc.

To receive token 10 in connection with an account, the person requesting the token (i.e., the account holder) submits a biometric, such as a fingerprint, to the token issuing entity, such as a bank. Submission of, for example, a finger print may be carried out in many different ways. For example, the issuing entity may mail a form to the account holder. The account holder fills out the questions asked on the form and supplies his finger print in a designated space on the form and as directed thereby. Thereafter, the account holder sends the completed form to the issuing authority. The account holder's finger print image is electronically scanned and captured by an image processing system and subsequently digitized and stored in a memory. Alternatively, the account holder may visit a registration station—administered by the issuing entity—to provide his finger print. The finger print is scanned and captured by an image processing system and subsequently digitized and stored in a memory.

The stored finger print image—obtained via either of the above methods—is thereafter centered, deskewed and sized. According to the present invention, additional security is provided by a second verification phase, during which secondary data matching is required. In one embodiment, this is accomplished by extracting the data from the finger print image. Specifically, in accordance with a preselected algorithm, a binary number is generated from the stored finger print image and is permanently stored in a database controlled by the issuing authority.

A copy of the stored finger print image is subsequently transferred to and stored in microchip 30 for future account access authorizations. The finger print image stored in microchip 30 may be in one of many commercially available formats, such as, Tiff, JPEG or bitmap. The image stored in microchip 30 is subsequently compared with the finger print image of the token holder taken at the transaction site whenever request to access the account is made by the token holder, as described further below.

FIG. 2 is a perspective view of an authorization terminal 70, in accordance with one embodiment of the present invention. Terminal 70 is positioned in a point of sale or a site where financial transactions and thus access to accounts occur. Terminal 70 includes, among other components, a slot 80 adapted to receive token 10 and to read data stored in microchip 30 disposed thereon. Slot 80 may also be adapted to read account related information stored, for example, on magnetic stripes 60.

Terminal 70 further includes a biometric sampler, such as a biometric scanner 90, that communicates with other components of terminal 70 through a port 100. If the biometric selected for account access is a finger print, scanner 90 is a fingerprint scanner, as known in the art. Terminal 70 receives power through a power port 110. Terminal 70 optionally includes a display, such as a light emitting diode (LED) display 120 and a keypad 130. Terminal 70 also includes a processor therein (not shown).

Such a processor may be configured to perform a number of functions. Such functions are typically performed by software code modules stored in a memory and executed by the processor. Alternatively, such functions may be carried out by specialized logic hardware modules (not shown). Still in other embodiments, such functions may be carried out by software modules executed by the processor in conjunction with other logic hardware modules.

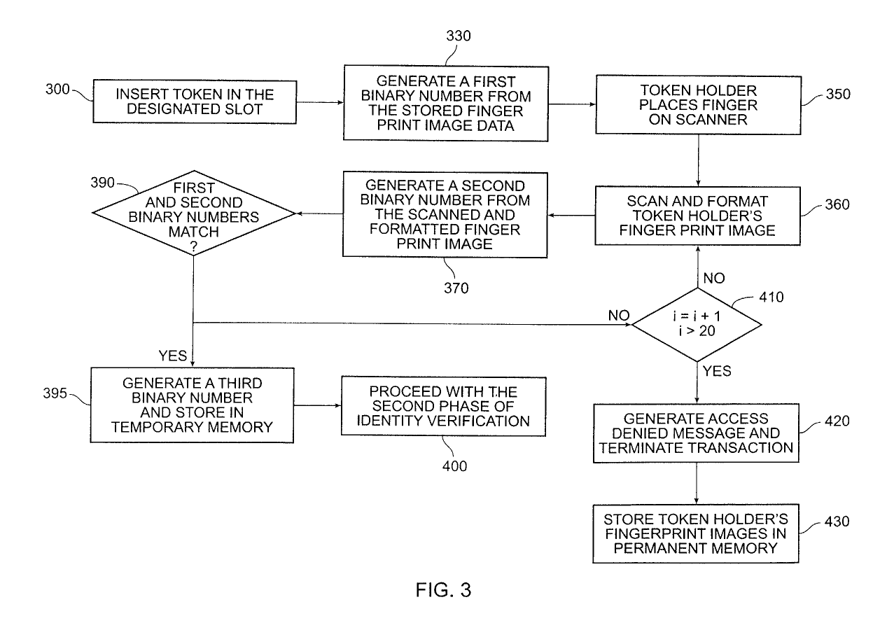

FIG. 3 is a flowchart illustrating the process of accessing an account during the first phase of identity verification, in accordance with one embodiment of the present invention. At initial step 300, token 10 is inserted into slot 80 of terminal 70, thereby causing the processor to read the finger print image data stored in microchip 30 of token 10. Thereafter, at step 330, in accordance with a preselected algorithm, the processor generates a binary number (hereinafter referred to as the first binary number) from the finger print image data stored in microchip 30.

At step 350, the token holder is instructed to place the finger, from which a print was taken earlier, on scanner 90. At step 360, the finger print is scanned by scanner 90 which is coupled to an image capture system (not shown), such as a camera system, thereby forming an image of the finger print. The scanned finger print image is subsequently formatted, i.e., centered, deskewed and sized by the processor. Thereafter, at step 370, in accordance with the preselected algorithm, the processor generates a binary number (hereinafter referred to as the second binary number) from the finger print image that was scanned by scanner 90 and was subsequently centered, deskewed and sized by the processor and the image capture system.

At step 390 the processor compares the first and second binary numbers to determine whether they match each other within a predefined tolerance limit. If there is a match, then at step 395 the processor extracts a predefined portion of either the first or the second binary numbers and stores the extracted portion (hereinafter referred to as the third binary number) in a memory. It is understood that the third binary number may be encrypted in a manner known in the art. Furthermore, it is understood that the third binary number may be formed from either contiguous or non-contiguous bits of the first or the second binary numbers. If a match is found between the first and second binary numbers, the identity verification or account access authorization proceeds to the second phase, as shown by step 400.

If no match is found between the first and second binary numbers, then at step 410 a counter (not shown) is incremented and the process returns to step 360 at which point the card holder's finger print is scanned again to from a new image therefrom, as described above. The process is so repeated, for example, 20 times or until a match occurs between the first and second binary numbers. Each scanned image of the card holder's fingerprint is saved in a temporary memory. If, for example, after 20 repeats of step 360 (i.e., i>20), no match is found between the first and second binary numbers, then at step 420, access to the account is denied and a message indicating the denial appears on display 120, at which point the process of accessing the account is terminated. If the process is so terminated, then at step 430 the scanned images of the cardholder's fingerprint is delivered from the temporary memory to a relatively more permanent memory for possible transfer to law enforcement agencies.

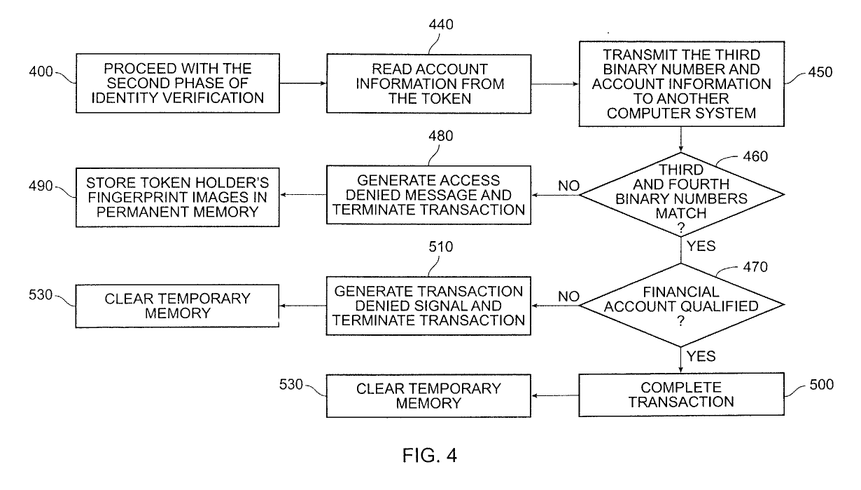

As shown in FIGS. 3 and 4, if a match exists between the first and second binary numbers, account access authorization proceeds to step 440 at which point additional account information stored in token 10 may be read therefrom. Such additional account information which may include, for example, the account number, the name and the address of the account holder, or the like, may be also stored in, for example, microchip 30, medium 40 or the magnetic stripes 60, as described above.

If such additional information is stored in a magnetic stripe, the token holder may be instructed to remove token 10 from slot 80 and swipe the token through slot 80. Alternatively, token 10 may be swiped through another opening formed in terminal 70, thereby to enable a magnetic read device (not shown) to read any information stored on the magnetic stripe, as known in the prior art. The cardholder may be instructed to place token 10 in or remove token 10 from slot 80 by, for example, a message shown on display 120, or by an audible signal generated by a speaker (not shown) attached to terminal 70.

At step 450, the third binary number is appended to any account information that is read at step 440. The third binary number and any account information appended thereto is subsequently transmitted to another computer system (not shown) under the control of the issuing entity and which may be stationed at a different physical location than terminal 70.

At step 460, the computer system receives and separates the third binary number from any account information appended thereto. The computer system also retrieves the binary number that is stored in the database (hereinafter referred to as the fourth binary number) and which is controlled by the issuing entity, as described above. Thereafter, the computer system compares the third and fourth binary numbers to determine whether they match. If the third and fourth binary numbers match within a predefined tolerance limit, the process moves to step 470, described below.

If, on the other hand, no match is found between the third and fourth binary numbers within the predefined tolerance limit, access to the account is denied and the transaction attempt is terminated, a shown in step 480. Furthermore, at step 480, a message corresponding to this denial is displayed on display 120 or broadcast via the speakers attached to terminal 70.

If the process is so terminated, then at step 490, the scanned images of the token holder's finger print images are stored in a permanent memory for possible transfer to law enforcement agencies. Furthermore, terminal 70 is then reset for the next transaction.

If there is a match between the third and fourth binary numbers, identity verification is successful. Accordingly, as indicated in step 470, the account is analyzed to determine whether it meets one or more qualifying requirements (e.g., account is not overdrawn, credit limit not exceeded, token holder is authorized entry, etc.). If the account meets the qualifying requirements, as shown in step 500, the desired account transaction occurs and a verified code or other information indicating acceptance of the transaction is generated and transmitted to display 120. Subsequently, at step 530 the temporary memory which stores the fingerprint images taken at the transaction site is erased. Terminal 70 is similarly reset for the next transaction.

If the account qualifying requirements are not met, then at step 510, a transaction denied signal is generated and transmitted to display 120 and the account access process is terminated. If the process is terminated, then at step 520 the temporary memory which stores the fingerprint images taken at the transaction site is erased. Terminal 70 is similarly reset for the next transaction.

Although the invention has been described in terms of the illustrative embodiment, it is understood by those skilled in the art that various changes and modifications may be made to the illustrative embodiment without departing from the spirit or scope of the invention. For example, terminal 70 may incorporate or be used in conjunction with a point-of-sale token reader known in the art.

It is understood that token 10 may include, in addition to credit/debit cards, a passport, driver license, or door/zone access card. The scope of the present invention is not limited in any way to the illustrative embodiment shown and described.

For purposes of the present invention, the term “account” is to be broadly construed to include a right or rights accessible based on positive user identification, such as, but not limited to, financial accounts, driving privileges, foreign travel privileges, access to restricted areas and the like.

The drawing figures are intended to illustrate the general manner of construction and are not to scale. In the description and in the claims, the terms left, right, front and back and the like are used for descriptive purposes. However, it is understood that the embodiment of the invention described herein is capable of operation in other orientations than are shown and the terms so used are only for the purpose of describing relative positions and are interchangeable under appropriate circumstances.

What is claimed is:

1. A token adapted to provide access to an account, the token comprising:
a memory configured to store an image of a biometric.

2. The token of claim 1 wherein said memory is an integrated circuit configured to store the image of the biometric.

3. The token of claim 2 wherein said biometric image is a finger print image stored in the memory in one of Tiff, JPEG and bitmap formats.

4. The token of claim 3 further comprising:
a magnetic stripe adapted to store data related to the account.

5. The token of claim 4 wherein said token is a card.

6. The token of claim 5 wherein said card is formed from material selected from a group consisting of plastic and metal.

7. A system adapted to receive a token, said token comprising an integrated circuit memory configured to store an image of a biometric, said token adapted to provide access to an account, said system comprising:
a processor configured to read the biometric image stored in the integrated circuit memory disposed in the token.

8. The system of claim 7 wherein said processor is further configured to generate a binary number from the stored image of the biometric and in accordance with a preselected algorithm.

9. The system of claim 8 further comprising a biometric sampler adapted to sample and capture an image of at least one biometric of the token holder at the location in which the system is stationed.

10. The system of claim 9 wherein said processor is further configured to generate a second binary number from the at least one biometric image of the token holder sampled and captured at the location in which the system is stationed, wherein said second binary number is generated in accordance with the preselected algorithm.

11. The system of claim 10 wherein said processor is further configured to compare the first and second binary numbers to determine whether they match within a predefined tolerance limit.

12. The system of 11 wherein said processor is further configured to generate a third binary number from one of the first and second binary numbers if the first and second binary numbers match each other within the predefined tolerance limit, wherein said third binary number is generated in accordance with a second preselected algorithm.

13. The system of claim 12 wherein said third binary number has fewer bits than either of the first and second binary numbers.

14. The system of claim 13 further comprising a second processor configured to receive the third binary number from the first processor.

15. The system of claim 14 wherein said first and second processors are located at different sites.

16. The system of claim 15 wherein said second processor receives the third binary number from the first processor via wired or wireless communication lines.

17. The system of claim 16 wherein said second processor is coupled to a database which maintains a fourth binary number extracted from a same biometric image source from which the biometric image stored in the memory is supplied, wherein said fourth binary number is extracted in accordance with the second preselected algorithm.

18. The system of claim 17 wherein said second processor is configured to retrieve the fourth binary number from the database and compare the retrieved fourth binary number to the third binary number it receives from the first processor to determine whether a match exists between the third and fourth binary numbers within a second predefined tolerance limit.

19. The system of claim 18 wherein if the second processor determines that a match exists between the third and fourth binary numbers then access to the account associated with the token is granted.

20. The system of claim 19 wherein if the first processor determines that the first and second binary numbers do not match each other within the first predefined tolerance limit then access to the account associated with the token is denied.

21. The system of claim 20 wherein if the second processor determines that the third and fourth binary numbers do not match each other within a second predefined tolerance limit then access to the account associated with the token is denied.

22. The system of claim 21 wherein the second processor further receives information related to the account with which the token is associated with from the first processor.

23. The system of claim 22 further comprising:
a key pad configured to enable the token holder to enter information related to the account into the system; and
a display configured to display messages to the token holder.

24. The system of claim 23 further comprising:
a magnetic read device adapted to receive information stored on a magnetic medium disposed on the token.

25. The system of claim 24 wherein the at least one biometric sample is a finger print sample and wherein the image of the at least one biometric sample of the token holder sampled and captured by the biometric sampler is formatted according to one of Tiff, bitmap and JPEG image format standards.

26. A method of forming a token adapted to provide access to an account, the method comprising:
forming a memory;
storing an image of a biometric in the memory; and
disposing the memory on the token.

27. The method of claim 26 wherein said memory is an integrated circuit memory configured to store the image of the biometric.

28. The method of claim 27 wherein said biometric image is a finger print image.

29. The method of claim 28 wherein said finger print image is stored in the memory in one of Tiff, bitmap and JPEG formats.

30. The method of claim 29 further comprising:
disposing a magnetic stripe adapted to store data related to the account on the token.

31. The method of claim 30 wherein said token is a card.

32. The method of claim 31 wherein said card is formed from material selected from a group consisting of plastic and metal.

33. A method of authorizing access to an account with a token, the method comprising:
receiving the token on which a memory configured to store an image of a biometric is disposed; and
reading the biometric image stored in the memory disposed on the token.

34. The method of claim 33 further comprising:
generating a binary number from the biometric image stored in the memory in accordance with a preselected algorithm.

35. The method of claim 34 further comprising:
capturing at least one biometric image of the token holder at the location in which access to the account associated with the token is requested.

36. The method of claim 35 further comprising:
generating a second binary number from the at least one biometric image captured from the token holder in accordance with the preselected algorithm.

37. The method of claim 36 further comprising:
comparing the first and second binary numbers to determine whether they match within a predefined tolerance limit.

38. The method of claim 36 further comprising:
extracting a third binary number from one of the first and second binary numbers if the first and second binary numbers match each other within the predefined tolerance limit, wherein said third binary number is extracted in accordance with a second preselected algorithm.

39. The method of claim 38 wherein said third binary number has fewer bits than the first and second binary numbers.

40. The method of claim 39 further comprising transmitting the third binary number to another location via wired or wireless communication lines.

41. The method of claim 40 further comprising:
comparing the transmitted third binary number to a fourth binary number maintained in a database to determine whether a match exists between the third and fourth binary numbers within a second predefined tolerance limit, wherein said fourth binary number is extracted from a same biometric image source from which the biometric image stored in the memory is supplied, wherein said fourth binary number is extracted in accordance with the second preselected algorithm; and
granting access to the account associated with the token if the third and fourth binary numbers match within a second predefined tolerance limit.

42. The method of claim 41 further comprising:
denying access to the account associated with the token if the third and fourth binary numbers do not match within the second predefined tolerance limit.

43. The method of claim 42 further comprising:
transmitting account related information via the wired or the wireless communication lines, wherein the account related information are retrieved from the token.

44. The method of claim 43 further comprising:
receiving information related to the account from the token holder; and
displaying messages related to the account to the token holder.

45. The method of claim 43 further comprising:
storing account related information on a magnetic stripe disposed on the token.

46. The method of claim 45 wherein biometric image is stored in the memory according to one of Tiff, bitmap and JPEG image format standards.

47. The method of claim 46 wherein said biometric is a finger print.

48. The method of claim 47 wherein said memory is an integrated circuit memory.
